(19) United States
(12) Patent Application Publication
(10) Pub. No.: US 2008/0163113 A1
(43) Pub. Date: Jul. 3, 2008

(54) Method for user customized single screen order taking

(76) Inventor: Walter Michael Ewald, Berkeley Heights, NJ (US)

Correspondence Address: Walter Ewald, 113 Briarwood Drive West, Berkeley Heights, NJ, 07922, US

(21) Appl. No.: 11/648,879

(22) Filed: Jan. 3, 2007

(51) Int. Cl. G06F 3/048; G06Q 30/00

(52) U.S. Cl. 715/810; 705/27

(57) ABSTRACT

A method is described for user customized single screen order taking. The method saves users time to submit subsequent orders by storing their selection of items and having the system use that stored information to avoid selecting the desired items for each subsequent order. In practice, upon initial logon, a menu of items is presented to the user in response to the users inputted identification and password. The user can then select a subset of items from the displayed menu for the present and subsequent logons. A single data entry screen presenting the specific data entry needs for the selected items then is displayed on the present and subsequent logins. This ordering method also permits the user to save all data entered on a data entry screen in modified or unmodified format for submission at a subsequent time for fulfillment. Additional time is saved by the user in the placement of orders by positioning all required data fields in different regions that the non-required data fields in the data entry screen.

### BACKGROUND OF THE INVENTION

1. Field of the Invention

This invention relates generally to the field of Internet-based communications and, more particularly, to a method for taking customer orders using a customized single screen for the input of required ordering data.

2. Description of Prior Art

The explosive growth of the Internet as a publication and interactive communication platform has created an electronic environment that is changing the way business is transacted. Companies often build websites to take orders from customers over the Internet. Many such order-taking systems however, do not save information associated with a specific user for use in enhancing the order taking process. Systems without saved information, typically require the user to select their desired items from a menu or catalog that is the same for all users.

Often data required to fulfill an order for items, such as goods or services, cannot be fully determined until the user selects the desired items for the specific order. Some electronic ordering systems require preliminary data be provided in order to select the appropriate items to be displayed on the ordering menu or catalog. These systems however often result in having the user enter too much or too little information before selecting items to be displayed. Systems requiring preliminary data prior to display of the ordering menu or catalog also don't give the user flexibility to use different data for a field that is common across items, such as last name wherein the user might want to user maiden name to fulfill one service such as college degree verification, but not for the other service such as a credit check.

Many ordering systems use a separate screen to enter data associated with each item to be acquired. This delays the ordering process, as it requires data to be transmitted back and forth across the Internet to generate a new screen for each item. The transmission interval results in a direct delay in the time it takes the user to enter an order, and an indirect delay as it interrupts continuity in the user data entry process.

A number of innovations have been proposed to overcome the above deficiencies and improve the ordering process.

For example, U.S. Pat. No. 07,028,261 presents a method to store information associated with a users activity and actively modifies each browsing experience according to that user's browsing history. While this system can present the user with more appropriate navigation choices, it neither presents a menu of items for order, nor bypasses a menu to display of the data entry screen for the item or items to be ordered.

An electronic ordering process, which employs a user profile to suggest items for purchase that are most likely to be of interest to the user, is described in US Patent Application 20030037041. While this process reduces the number of items offered for selection by the user, product selection is still required before display of the data entry screen for the item or items to be ordered.

US Patent Application 20050091156 identifies a method to correlate content to present to a user with demographic and psychographic data it previously stored for that user. This method can improve the users experience, but it does not let the user select the products and/or services that they want displayed. This process also requires product selection before display of the data entry screen for the product to be ordered.

US Patent Application 20050204276 consists of a framework that uses questionnaires and other methods to gather preference information about a customer, and uses that information to adjust the offer it makes to that customer. This is time consuming for the customer and frequently does not adequately reflect the future needs of the customer for items. The framework also does not directly let customers select the products and/or services that they want displayed. This process also requires product selection by the customer before display of the data entry screen for the product to be ordered.

US Patent Application 20040268228 provides a framework that simplifies the development of customizable web pages. The framework described in this patent application did reduce the development effort to develop many web applications, but it did not introduce new simplifications to the order entry process.

An additional complexity of taking customer orders occurs after items are identified, and specific data are either required or just useful to fulfill the order. Both the “required” data and the “useful” data typically are intermingled on the data entry screen, with the “required” data differentiated graphically via an asterisk or other notation. This intermingling of “required” and “useful” data adds burden and delay to the users that want to enter only the required data.

Inefficiencies further exist in the order entry process, when different items have data requirements for the same field types. In such cases, the user usually wants to use the same data for the same field type of each item, but occasionally needs to use different data. Re-entering the same data for a subsequent number of items is time consuming and burdensome.

### BRIEF SUMMARY OF THE INVENTION

The above deficiencies are overcome by the present invention, which provides a highly efficient method for single screen electronic ordering of various items such as goods and/or services. The order taking method comprises initially displaying a logon screen on a website to permit the user to logon by inputting a unique username for identification, and a password for authentication. Based on the username, a menu of authorized items is presented on a screen for the user or the system administrator on behalf of the user, to select a primary subset of items from the menu. The selected primary subset of items is stored for the present and subsequent logons and the data entry needs are determined for the selected primary subset of items. A primary data entry screen then is displayed to the user that presents only the data entry needs for the selected primary subset of items during that logged in session. After entry of all requested data, the user may submit an order for fulfillment directly from the displayed data entry screen. Immediately upon subsequent logons, a data entry screen is displayed that presents only the data entry needs of the selected items thereby bypassing display of the items menu and permits order fulfillment from a single data entry screen.

In an enhanced version of the electronic ordering method of this invention, the user is permitted to select from the menu of authorized items, one or more alternate subsets of items that is in addition to the subset of items initially selected. Each alternate subset of items is stored along with the initially selected subset and the data needs are determined for the alternate selected subset of items. A data entry screen that presents only the data entry needs of the selected alternate subset is displayed via a link from the data entry screen for the initially selected subset of items. The displayed screen of data entry needs for the alternate subset of items permits the user to directly submit an order for fulfillment. Additional ordering efficiencies are achieved by positioning required data fields in different regions on the data entry screen than non-required fields. The ordering method of this invention also permits the user to save all data entered on the data entry screen for an item, and subsequently submits the data in modified or unmodified form for fulfillment during the present or subsequent session.

### BRIEF DESCRIPTION OF THE DRAWINGS

In order to describe the manner in which the above recited and other advantages and features of the invention can be obtained, a more particular description of the invention briefly described above will be rendered by reference to specific embodiments thereof, which is illustrated, in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a flow diagram illustrating the overall order taking process of this invention.

FIG. 2 is an illustration of a computer monitor screen displaying a menu of authorized items based on user identification, for selection by the user of a subset of items to be acquired.

FIG. 3 illustrates a computer monitor screen that presents the primary data entry needs for the selected subset of items.

### DETAILED DESCRIPTION OF THE INVENTION

The present invention extends to a method for user customized single screen order taking. The order taking may be for various items, such as goods/products or services, or a combination of both, and is particularly useful for taking orders for background checks on a company's potential employees. In this case, employees of the company, referred to herein as recruiters, wish to place orders for background checks on many potential employees. These require providing data specific to the potential employee such as last name, first name, date of birth, previous employer, and college attended. Recruiters usually request the same services, with an occasional exception. The recruiters however, cannot place all the orders at once, as the process is triggered by an event such as a job offer. It is important once this event occurs for the recruiter to provide this information and place the order in an efficient manner. The order process also should have the flexibility to allow for exceptions such as different services for some orders, or different last names to fulfill different services within the same order. For example, a recruiter may wish to do a credit check under the current last name, but they may want to do a college degree check or previous employment check under a maiden last name.

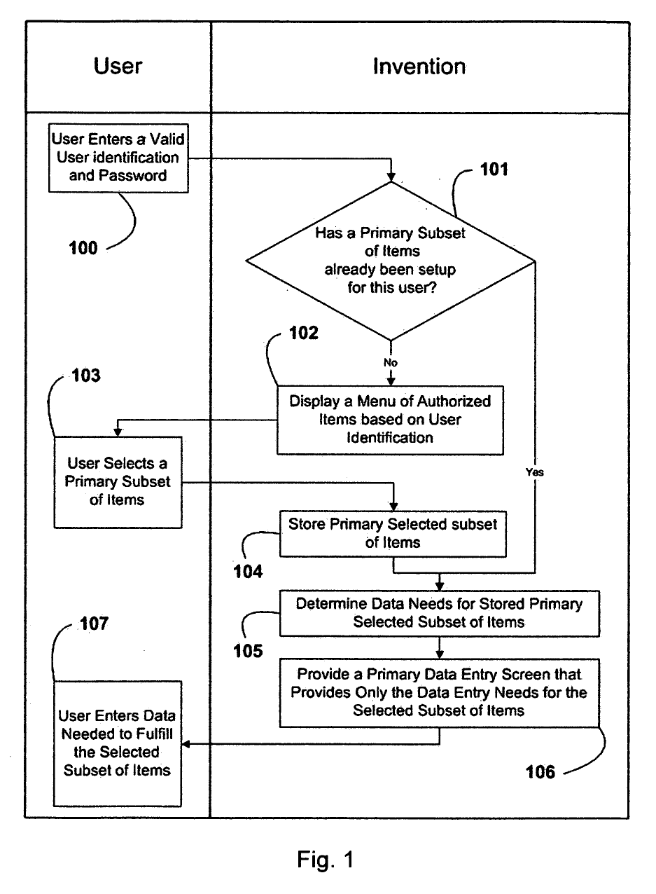

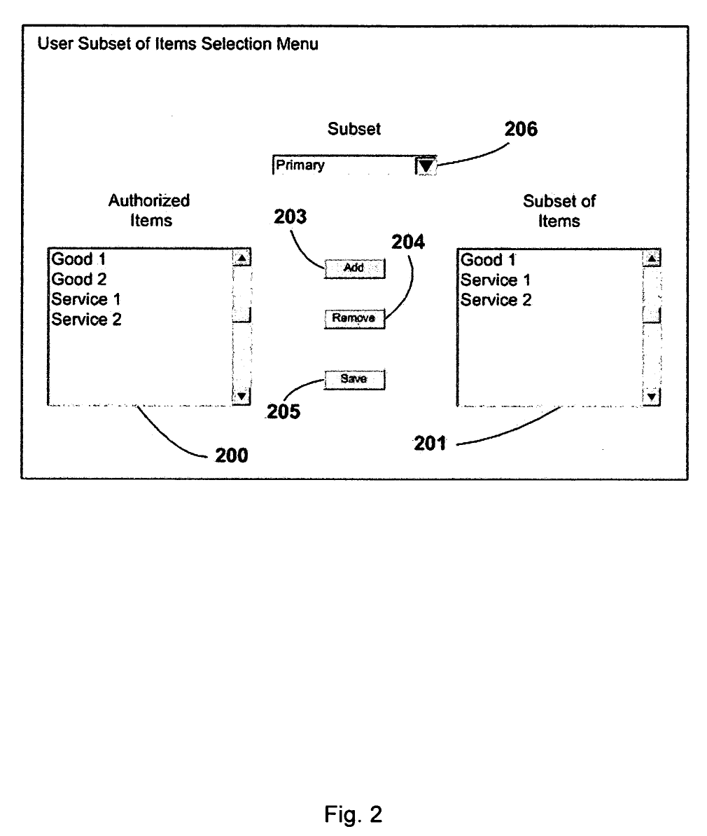

Referring more particularly to the process overview illustrated in FIG. 1, step 100 displays a screen to permit a user to logon to an Internet site by inputting user identification and password. After logon, step 101 determines if a primary subset of items has already been setup for this user. If a primary subset of items has not already been setup for this user, step 102 provides a screen such as shown in FIG. 2, having a menu of authorized items based on user identification. For example, the user's company may typically want a criminal background check done on their potential employees, but may not want to authorize some of their users to do a credit check on potential employees. A credit check therefore would not be on the list of authorized items for such users. The user then is permitted by step 103 to select a primary subset of items from the authorized items on the menu.

The selected primary subset of items is stored with step 104 for the current and subsequent logons. Step 105 determines the data needs for the selected primary subset of items. For example, the data needs for a background check often include the name, social security number and birth date of the individual for whom the background check is desired. Based on the primary subset of items, which have been selected by the user, a primary data entry screen is presented to the user in step 106 soliciting only the data needs for the selected primary subset of items. In step 107, the user then enters the data necessary for the vendor to fulfill the selected subset of items.

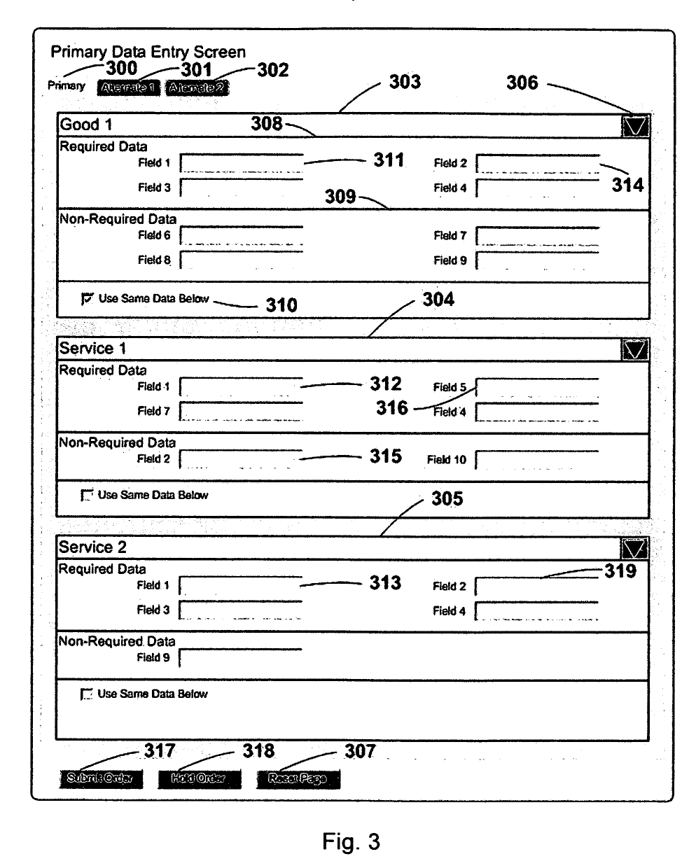

On logons by the user subsequent to the initial login, the data needs of the previously selected subset of items are immediately determined in step 105 upon receipt of the user identification and password. A primary data entry screen shown in FIG. 3 that provides only the data entry needs for the subset of items selected in the initial logon then is displayed in step 106 to the user. Upon entry of the data entry needs by the user in step 107, the vendor can fulfill the requested order for items. By eliminating the need for display of a menu of authorized items during logons subsequent to the initial logon, the subsequent logon order placement process is quicker for the user and the vendor, and is easier for the user.

FIG. 2 illustrates a screen for the user to select a primary subset of items for this and subsequent logons. The menu 200 of authorized items is generated by restricting the full menu of items offered, to just those which are authorized for this user identification. The user selects the subset of items 201 by choosing desired items from the menu 200 of authorized items and then selecting the “Add” button 203. The user can remove any of the items from their selected subset of items by selecting the item from the selected subset of items menu 201 and then selecting the “Remove” button 204. The user can store the primary selected subset of items for this and subsequent logons by selecting the save option 205. Once save option 205 is selected by the user the data entry screen shown in FIG. 3, as opposed to the menu in FIG. 2, will initially appear upon subsequent logons by the user. However, the menu in FIG. 2 is accessible for modifications during this and subsequent logons.

With reference to FIG. 2, the user can select alternate subsets of authorized items by selecting a different data entry screen 206, which changes this screen from a “Primary” menu to any one of a user's desired alternate menus. The user can then select an alternate subset of items in the same manner as was used to select the primary subset of items.

FIG. 3 illustrates a screen for the user to enter the data needed to fulfill the order requirements for the primary subset of items. The primary subset of items 300 are displayed on this figure to include the same subset of items 201 previously selected and saved by the user in FIG. 2 (i.e., Good 1, Service 1, and Service 2). If the user selected alternate subsets of items in FIG. 2, the user can then access the alternate data entry screens for these alternate subsets through selection buttons 301 and 302. These alternate data entry screens are identical to the primary data entry screen shown in FIG. 3, except for the items for which data entry is sought. The screens also operate in the same manner as the primary data entry screen. The data entry needs for each of the selected primary items 303, 304, and 305 are shown on a single screen. The user can temporarily delete any of the previously selected items directly from this screen via a drop-down menu 306 for that item. The user can select to clear all entered data from this page and restore any temporarily deleted services via selecting the “Reset Page” option 307.

As shown in FIG. 3., required data fields 308 are positioned in a different region for each service than the non-required data fields 309 on the data entry screen. This approach is in contrast to the approach of presenting required and not required data fields together, and using an identifier such as an asterisk to differentiate them for the user. Positioning all required data fields in a single region for an item permits the user to restrict data entry considerations only to the required data region of the screen. This positioning also allows users to allow a single-key stroke such as tab to move successively through only the required fields, which accelerates the order entry process. Although the time and convenience benefits are small for a single item with few fields, the benefits can become significant when many items and/or fields are presented on the screen.

The data entry section for each item includes an option to copy all data for the same field type for that service to all services below via a single mouse-click 310. The same field types are indicated by the name of the field, such as 311 and 312 are both labeled “Field 1”. The user is also permitted to enter different values for the same field type by entering different values in Field 1 for “Good 1” 311, Field 1 for “Service 1” 312, and Field 1 for “Service 2” 313. This copy to below capability is independent of whether the data is in the “Required” or “Non-Required” section as selecting the “Use Same Data Below” for “Good 1” 310 will copy data from Field 2 of “Good 1” 314 to Field 2 of “Service 1” 315, and Field 2 of “Service 2” 319, as well as all other like fields from “Good 1” to the like fields in Service 1 and Service 2. The fields that are presented for different items are dependant on the fulfillment needs for that item and so fields such as 316 which were not displayed for earlier items such as 303, can be displayed for subsequent items such as 304.

The user can submit the data for fulfillment directly from this single screen 317 or may elect to save all data entered on the data entry screen, without the data submitting for fulfillment 318. In the event the data is saved, this data will appear on this screen upon subsequent sessions and the user can then modify the data and/or submit the data for fulfillment during this or a subsequent session.

The invention can be implemented as a website; that is an application running on a web server, using a database, accessible by users via an Internet browser. Although this architecture is widely known in the field, and can be accomplished using many different frameworks, a detailed description is provided herein as an example using the ASP.NET 2.0 framework, the details of which can be found in McDonald [Matthew McDonald, 2006, “Beginning ASP.NET 2.0 in C # 2005”, published by Apress]. This documentation includes implementation guidance for the framework that is introduced in US Patent Application 20040268228.

When a user requests the screen shown in FIG. 2. via their web browser, the application queries a database that contains the list of previously identified authorized items for this user. The list is presented on this screen in a manner that the user can select a primary subset, as well as alternative subsets. Such an implementation can be accomplished using a “List Box” (See McDonald pp 487-506, 930-935). The primary and alternative subset lists of items are stored in a custom database table.

The implementation of the single screen for the user to enter the data needed for fulfillment involves many considerations on the types of data that are needed. Defining some terms is helpful to distinguish the types of data that are being described in this document. Each element of data, such as “Last Name” is referred to herein as a “field”. The fields needed to fulfill an individual item are referred to herein as “item fulfillment data”. Some fields may be unique across items, and some may not. A field, such as “Last Name” that is required for two items, is referred to herein as a “like” field, even though the value the user may enter for this field can be different when it is associated with different items.

The item fulfillment data is setup at the time the item is programmed into the application, as is the identification as to whether each field is required or non-required [By “programmed into the application”, it is meant that this activity is executed prior to installation of the application on the web server, or design-time, as opposed to “run-time” which occurs when the user submits a request via their web browser. Although the example implementation below programs this information into the code, such information could be stored in a database]. The identification of like fields is also programmed into the application. When a user requests a page of the type shown in FIG. 3, the system needs to use the above information to determine the data needs for the desired stored subset, either primary or alternate, of items and present them to the user for data entry.

Each item is created in the application as a .Net custom web part. Each web part is a separate custom web part class, which inherits from the web part class as described in McDonald (pp. 1029-1061). A custom database table keeps track of which webparts are currently active on each subset, and so this allows use of the native .Net functionality to manage the web parts for all of the subsets without additional code. The web part manager native functionality saves the data entered into each web part control for future logins. This process can also be activated by the “Hold Order” 318 functionality. The “Reset Page” functionality 307 deletes and regenerates the web part associations with the page. The “Submit Order” functionality 317 saves all data for the current subset into custom tables for separate fulfillment processing.

Each subset of items is programmed as a collection of web parts in web part zone. Each webpart zone is contained in a separate ASP Panel (see McDonald 177-186). The use of an ASP Panel allows the different subsets to be displayed via the user clicking on their desired subset 300, 301, 302 via use of the ASP Menu Control (McDonald 420-425).

The web parts are programmed using a standard approach such as described in Evjen (Evjen, 2006, “Professional ASP.NET 2.0”, published by Wrox, pp. 631-668). This includes defining each web part field as a variable, tie these variables to controls such as text boxes or drop downs for the user to use to enter their information, define labels for these controls, initialize all children controls, render all children controls to the web part, and then render the content as HTML.

The “Use Same Data Below” 310 functionality is initialized in the web part and activated via scripting on the client side, such as Javascript. The same variable names are used for like fields, which the code then uses in the script to change values each time the user activates the “Use Same Data Below” control. This use of Javascript is explained in detail in Zakas (Nicholas Zakas, “Professional Javascript for Web Developers”, 1999, Published by Wrox). The “Use Same Data Below” 310 functionality could also be accomplished using native web part functionality, which ties together like fields from separate web parts (Evjen, 2006, pp 631-668).

An implementation in an IBM-PC machine format for a Windows compatible operating system is included on CD with this application. The application runs in a Microsoft .Net 2.0 environment using a local Microsoft SQL 2005 database, which is also on this CD.

1. A method for User Customized single screen order taking comprising:
Displaying a screen to permit a user to logon by inputting user identification and password
Providing a menu of authorized items based on user identification,
Permitting the user to select a primary subset of items from the authorized items on the menu,
Storing the selected primary subset of items for this and subsequent logons
Determining the data entry needs for the primary selected subset of items
Providing a primary data entry screen to the user that presents only the data entry needs for the selected primary subset of items during that session and
Permitting the user to complete the data entry needs of the primary data entry screen and to submit the data directly for fulfillment
Displaying the primary data entry screen that presents only the data entry needs of the primary selected items immediately upon subsequent logons thereby bypassing display of the authorized items menu and permitting order fulfillment from a single data entry screen.

2. A method for User Customized single screen order taking according to claim 1 further including:
Permitting the user to select alternate subsets of items from the authorized items on said menu,
Storing the alternate selected subsets of items along with the primary subset of items for this and subsequent logons
Determining the data needs for the alternate selected subsets of items,
Displaying an alternate data entry screen that presents only the data entry needs of the selected alternate subset of items via a link from the data entry screen for the primary subset of items and
Permitting the user to submit the order for fulfillment directly from the displayed alternate data entry screen.

3. A method for User Customized single screen order taking according to claim 1 further including:
Positioning all required data fields in different regions than the non-required fields in the data entry screen.

4. A method for User Customized single screen order taking according to claim 1 further including:
Permitting the user to save all data entered on the data entry screen, to modify the data and subsequently submit the data in modified form for fulfillment.

5. A method for User Customized single screen order taking according to claim 1 further including:
Permitting the user via a single mouse click to erase all data previously entered for an order.

6. A method for User Customized single screen order taking according to claim 1 further including:
Permitting the user to copy, via a single mouse click, all data entered into a data field for one item to like data fields for all successive items.

7. A method for User Customized single screen order taking according to claim 1 further including:
Permitting the user to input on the data entry screen, different values for like data fields that are associated with different items.

8. A method for User Customized single screen order taking according to claim 1 further including:
Permitting the user to temporarily delete any of the items from the data entry screen. Permit the user via a single mouse click, to restore temporarily deleted items.

9. A method for User Customized single screen order taking comprising:
Displaying a screen to permit a user to logon by inputting user identification and password
Providing a menu of authorized items based on user identification
Permitting the user to select a subset of items from the authorized items on the menu
Determining the data entry needs for the selected subset of items
Providing a single data entry screen to the user that presents only the data entry needs for the selected subset of items,
Positioning all required data fields in different regions than the non-required fields in the data entry screen,
Permitting the user to submit data entered into said data fields directly for fulfillment from the single data entry screen.
